(19) United States
(12) Patent Application Publication
(10) Pub. No.: US 2006/0265933 A1
(43) Pub. Date: Nov. 30, 2006

(54) Ice fishing/shore fishing rod holder

(76) Inventor: David Allen Knock, Lennox, SD (US)

Correspondence Address: David Knock, 46797 SD HWY 44, Lennox, SD, 57039, US

(21) Appl. No.: 11/136,803

(22) Filed: May 26, 2005

(51) Int. Cl. A01K 97/10

(52) U.S. Cl. 43/21.2

(57) ABSTRACT

There is a large number of fishing rod holders described in the patent literature designed to be Assembled for use and disassembled for transport and storage. Many are very complicated and hard to Use and store. My rod holder is very a very simple one with only two moving parts and no assembly Or disassembly required. In it's folded position it will lay in the bottom of a 5 gallon pail. Being only 1½″ high and 10″ in diameter when folded several can be stored and transported at one time. To set up simply lift the pivoting arm to the desired position and turn the PVC rod butt Holder perpendicular to the circular base and you are ready for use.

### CROSSREFERENCE OF RELATED APPLICATIOIN

NOT APPLICABLE

### STATEMENTOF FEDERALY SPONSERED RESERCH OR DEVELOPMENT

NOT APPLICABLE

### NAMES OF THE PARTIES TO A JOINT RESERCH AGREEMENT

NOT APPLICABLE

### INCORPERATION BY REFERENCE OF MATERIAL SUBMITTED ON A COMPACT DISC

NOT APPLICABLE

### BACKGROUND OF INVENTION

The field of invention is sport fishing, more specifically the field of ice fishing. Although this rod h Holder can be used for shore fishing also. This invention eliminates several problems involved in ice Fishing by not having to assemble and disassemble unit. This also eliminates the possibility of losing Small parts. It has only two moving parts and needs only two simple movements to set up and take down. The first movement is to lift the pivoting arm to the desired position and the second is to turn the PVC rod But holder perpendicular to the circular base.

### BRIEF SUMMARY OF INVENTION

My invention, a circular folding fishing rod holder, is of very simple design and operation. It is Mainly designed for ice fishing but can also be used for shore fishing. The design is simple in that it only Has two moving parts, The PVC rod butt holder #1 and the pivoting arm #2. There are no parts to assemble Or disassemble so no parts can be lost or misplaced. The design is such that when folded the holder can Be carried or stored in a 5 gallon bucket.

### DETAILED DESCRIPTION OF THE SEVERAL VIEWS OF THE DRAWINGS

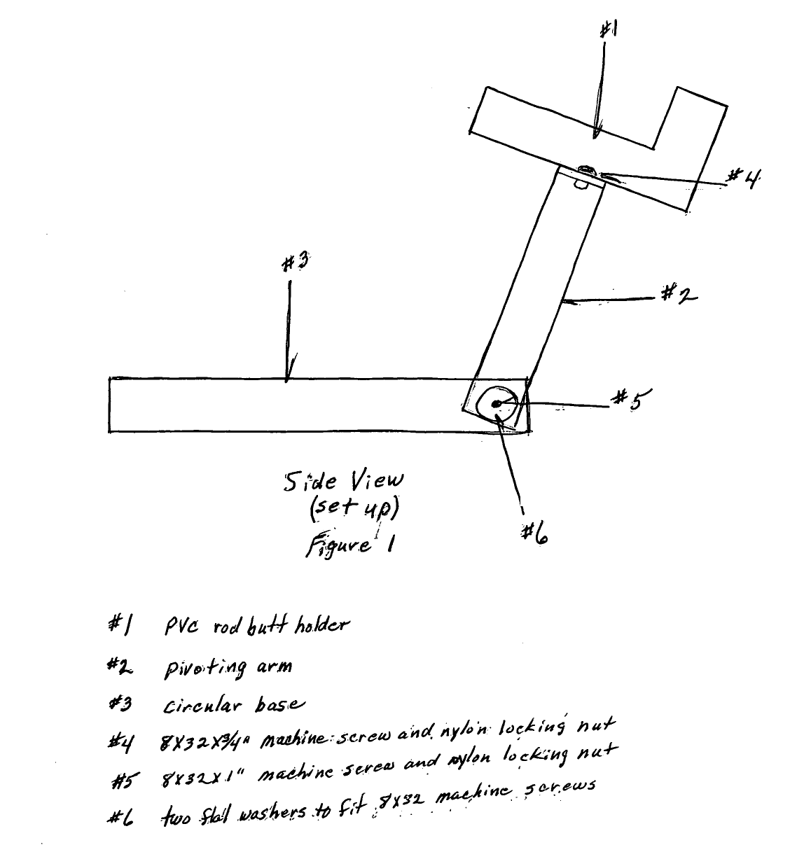

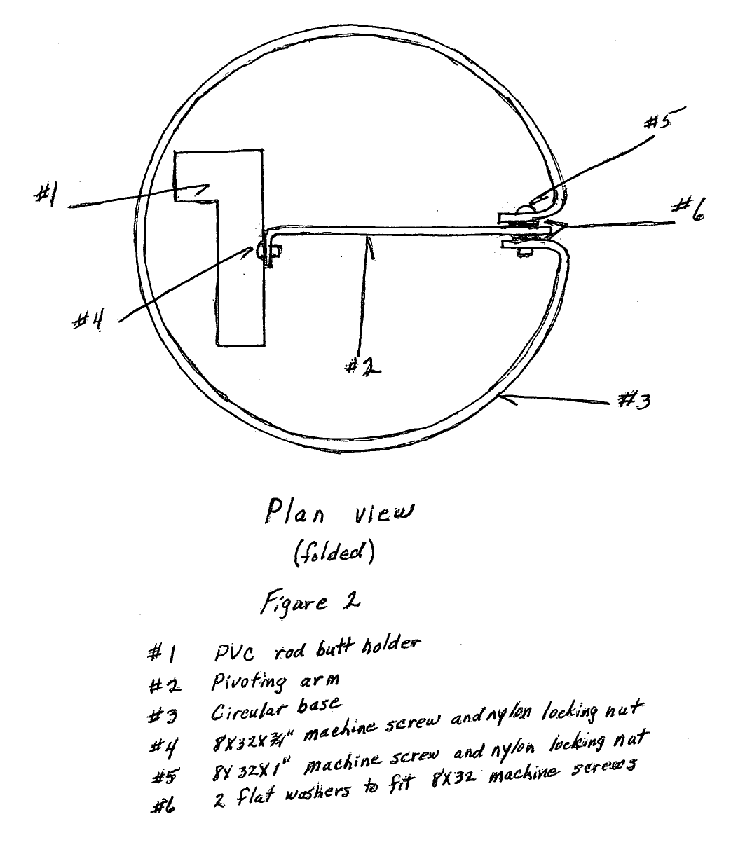

FIG. 1 shows the Rod holder in it's set up position. The PVC rod butt holder #1 is turned from it's stored position to it's Used position which is aligned across the circular base #3. The pivoting arm #2 is raised from it's stored Position to the desired angle to give the fishing rod the proper angle for use. The circular base #3 is Placed flat on the ice near the hole or on the ground adjacent to the water. If used on shore a stake with a Hook on the top end should be used to anchor the holder to the ground. A simple tent stake hooked over The circular base #3 near the pivoting arm #2 and pushed into the ground is sufficient. The 8×32×¾″ Machine screw and locking nut hold the PVC rod butt holder #1 to the pivoting arm #2. The locking Nut provides the proper tension to hold the rod butt holder in position. The 8×32×1″ machine screw #5 Holds the pivoting arm #2 to the circular base #3. The 8×32×1″ machine screw and locking nut #5 allow The tension to the pivoting arm to be adjusted to hold the pivoting arm #2 at the desired angle. The two flat Washer #6 are used one on either side of the pivoting arm #2 as shown in FIG. 2. They allow smoother Operation of the pivoting arm.

FIG. 2 shows the rod holder in it's folded position. The PVC rod butt Holder #1 is turned to lay horizontally with the circular base #3. The pivoting arm is pressed down inside the circular base #3 giving a stored size of approximately 1½″ high and 10″ in diameter.

### DETAILED DESCRIPTION

In making the rod holder one 32″ and one 8″ piece of 1′×⅛″ aluminum strap is used. First a 3/16″ Hole is drilled ½″ from each end of the 32″ piece and then a 90 degree bend is made 1″ from each end in The same direction. I make this bend with the use of a bench vice. I made a mark 1″ from the edge of the Jaw of the vice to use as a reference to make the bends needed to the aluminum strap. By using this mark I don't have to measure each bend.

I made bending device for the circular shape. I use a 2″ wide×6″ diameter steel ring which I cut And opened about ½″. I welded the ring to a flat piece of steel and drilled a ½″ hole in the center and Installed a ½″×4″ bolt to use as a pivot point. I then used a piece of flat steel about 18″ long and 1½″ Wide for the bending arm. I drilled a ½″ hole 1″ from one end and then a ¼″ hole 5¼″ from the first. In the second hole I used a ¼″×2½″ bolt to mount a 2″ hard rubber wheel to the bending arm. The ½″ hole In the bending arm is placed over the bolt in the center of the ring. This places the rubber wheel about ¼″ Outside the ring.

By placing one 90 degree bend in the slot in the ring the arm can be pulled around the ring Bending the aluminum strap as it goes. This will only bend the strap part way making it necessary to turn. The strap around and place the other 90 degree bend in the slot and repeat the process. It sounds like a long Process but should only take about 30 seconds to complete the process.

To make the folding arm of the rod holder I used the 8″ piece of aluminum. I drilled a 3/16″ hole ½″ from each end. Then using the bench vice I make a 90 degree bend on one end.

A 1¼″×3″ piece or PVC is needed to use as the part of the rod holder which receives the handle Of the fishing rod.

Begin by measuring 1′ in from one end and cut half way through, then from the opposite end cut Lengthwise to the first cut leaving a 2″ trough with a 1″ ring.

Assembly is done as follows: A 8×32×¾″ machine screw is placed through the hole in one end of The circular base, then one flat washer is placed on the screw. The folding arm is then placed on the screw With another flat washer next. The other 90 degree bend of the circular base is placed over the screw and a Self locking nut is tightened on the screw. A self locking nut is used to provide the proper tension so that The arm will remain in the position the angler wishes.

A 3/16″ hole is drilled in the bottom center of the PVC. The PVC is then mounted to the 90 degree Bend of the folding arm using a 8×32×¾″ machine screw and a self locking nut. The nut is tightened Sufficiently to hold the PVC in place and to allow it to turn when the arm is folded for storage.

The PVC is cleaned using mineral spirits and painted florescent orange to make it easier to see. Especially when ice fishing.

This rod holder being a circular folding unit differs from other rod holders since none are circular And designed to fit in a 5 gallon pail for storage and transport.

A list of materials needed is as follows:
1) 1′×⅛″×32″ aluminum strap
1) 1″×⅛″×8″ aluminum strap
1) 1¼″×3″ PVC nine
2) 8×32×¾″ machine screws
2) self locking nuts
2) flat washers to fit the 8×32 machine screws

I claim:

1. A folding rod holder having a circular one piece base and pivoting arm both Consisting of 1′×⅛″ aluminum strap and a PVC rod butt holder 3″ long Which is fastened to the top of the pivoting arm and turned perpendicular To the base when the pivoting arm is raised from the stored position to the Proper angle to hold the fishing rod in it's use position and when the pivoting Arm is folded down in it's stored position in the center of the circular base The unit measures about 10″ in diameter and 1½″ high and can be stored And carried in a 5 gallon pail.
